(19) United States
(12) Patent Application Publication
(10) Pub. No.: US 2008/0271412 A1
(43) Pub. Date: Nov. 6, 2008

(54) HOLLOW DOOR REINFORCEMENT

(75) Inventor: Paul L. Rubel, Clarkston, MI (US)

Correspondence Address: REISING, ETHINGTON, BARNES, KISSELLE, P.C., P O BOX 4390, TROY, MI, 48099-4390, US

(73) Assignee: PLR SOLUTIONS, LLC, Clarkston, MI (US)

(21) Appl. No.: 11/742,884

(22) Filed: May 1, 2007

(51) Int. Cl. E06B 3/00

(52) U.S. Cl. 52/784.16; 49/501

(57) ABSTRACT

A reinforcement is configured to be disposed between spaced apart panels of a hollow door, and includes an elongated body, a flange carried by the body, and a fastener passage extending through the elongated body and the flange.

### TECHNICAL FIELD

The present invention relates generally to adjuncts for doors and more particularly to a reinforcement for a hollow door.

### BACKGROUND

A hollow door typically includes spaced apart front and rear panels, and hardware carried by the door at the front panel. The hardware is usually mounted against a front surface of the front panel and is fastened to the door by screws extending through the back of the door and into threaded engagement with the hardware.

But such hardware fastening arrangements usually yield perpetually loose or wobbly hardware. Efforts to tighten such hardware frequently just collapse the door panels together behind the hardware, thereby leading to an eventual repeat of the looseness and wobbling.

### BRIEF SUMMARY

A reinforcement is configured to be disposed between spaced apart panels of a hollow door. The reinforcement includes an elongated body, a flange carried by the body, and a fastener passage extending through the elongated body and the flange.

### BRIEF DESCRIPTION OF THE DRAWINGS

Features and advantages of the present invention will be apparent to those of ordinary skill in the art from the following detailed description of preferred embodiments and the claims, with reference to the accompanying drawings in which:

FIG. 1 is a perspective view according to a presently preferred embodiment of a door reinforcement;

FIG. 2 is a front view of the door reinforcement of FIG. 1;

FIG. 3 is a side view of the door reinforcement of FIG. 1;

FIG. 4 is a perspective view according to another presently preferred embodiment of a door reinforcement; and

FIG. 5 is a cross-sectional view according to a presently preferred embodiment of a door assembly.

### DETAILED DESCRIPTION OF PREFERRED EMBODIMENTS

In general, an article and assembly will be described using several examples of presently preferred embodiments of a hollow door reinforcement that includes a flange, and a body configured to be disposed between spaced apart door panels, and having opposed mounting surfaces configured to bear compressive fastening forces of a hardware fastening arrangement.

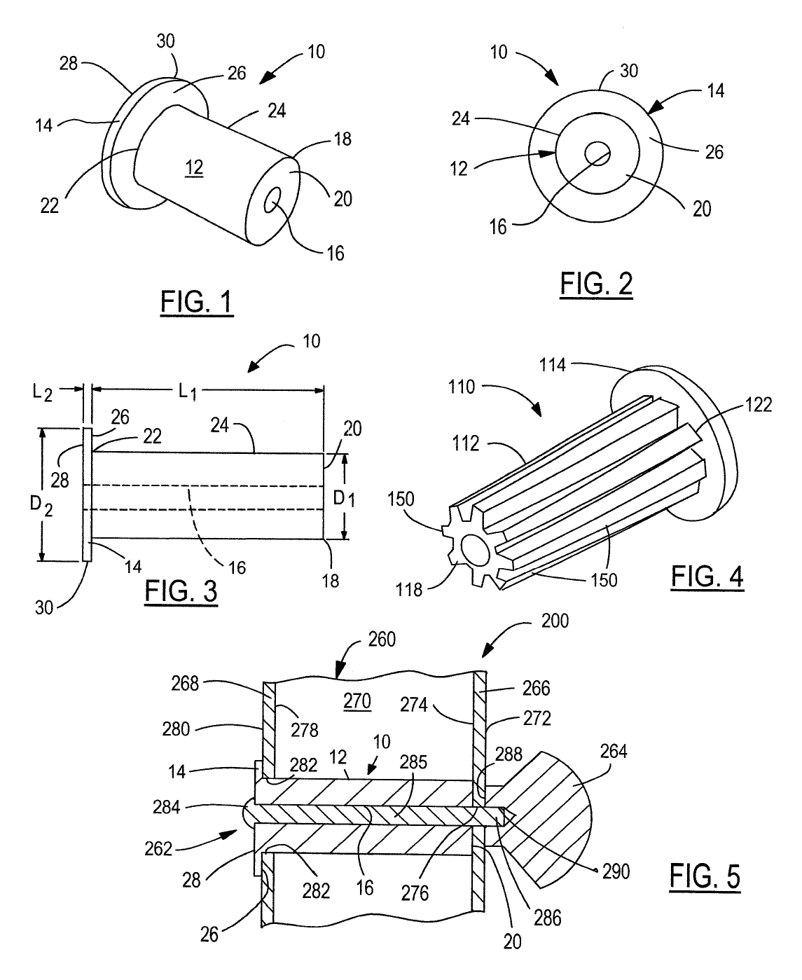

Referring specifically to the drawings, FIG. 1 illustrates a presently preferred embodiment of a reinforcement 10 for a hollow door (not shown). As will be described in greater detail below, the reinforcement 10 is adapted to be disposed between spaced apart panels of the door and behind door hardware to reinforce the door when the door hardware is fastened or tightened to the door. The reinforcement 10 generally includes a body 12, a flange 14 carried by the body 12, and a fastener passage 16 extending through the body 12 and the flange 14. The reinforcement 10 may be of unitary construction as shown, but may instead be of multiple-piece construction.

Referring to FIGS. 1 through 3, the body 12 may be elongated relative to the flange 14 and may include a front end 18 having a front surface 20, a rear end 22 at the flange 14, and an outer peripheral surface 24 therebetween. The front surface 20 may be substantially planar as shown, but may also be contoured, angled, or the like. The rear end 22 may be adapted to be integral with the flange 14, or may be adapted to be attached to the flange 14 in any suitable manner in the case of a multiple-piece reinforcement. The body 12 may be substantially cylindrical, as shown, such that it is substantially circular in transverse cross section but may also be of any other cross-sectional shape, for example, oval, square, rectangular, or the like. Accordingly, the outer peripheral surface 24 may be diametrical as shown, or may be contoured, angled, or of any other shape or profile.

The flange 14 is radially larger than the body 12 and may include a front surface 26, an oppositely disposed rear surface 28, and an outer peripheral surface 30 therebetween. The flange 14 may be substantially cylindrical as shown, such that it is substantially circular in transverse cross section but may also be of any other cross-sectional shape, for example, oval, square, rectangular, or the like. Accordingly, the outer peripheral surface 30 may be diametrical as shown, or may be contoured, angled, or of any other shape or profile.

The fastener passage 16 extends through the reinforcement 10 from the front surface 20 of the body 12, through the body 12 and the flange 14, to the rear surface 28 of the flange 14. The fastener passage 16 may be cylindrical as shown, but may instead be of any other suitable shape. Also, the fastener passage 16 may be of any suitable size, for example, on the order of about 11/64″.

Referring now to FIG. 3, the body 12 includes a radially outer dimension D₁ and, similarly, the flange 14 includes a radially outer dimension D₂. An example range of ratios of dimensions D₂ to D₁ may be on the order of about 1.1:1 to about 3.0:1. A more preferred range may be on the order of about 1.4:1 to about 1.7:1. An example ratio of dimensions D₂ to D₁ may be about 1.55:1. For example, an example value for dimension D₂ is about ¾″ and an example value for dimension D₁ is about 31/64″.

Still referring to FIG. 3, the body 12 includes a longitudinal dimension L₁ and, similarly, the flange 14 includes a longitudinal dimension L₂. An example range of ratios of dimensions L₁ to L₂ may be on the order of about 30:1 to about 10:1. A more preferred range may be on the order of about 25:1 to about 15:1. An example ratio of dimensions L₁ to L₂ may be about 20:1. For example, an example value for dimension L₁ is about 1¼″ and an example value for dimension L₂ is about 1/16″. Those skilled in the art will appreciate that the size of the reinforcement 10 may vary from one door application to another. More particularly, those skilled in the art will understand that the reinforcement 10 may be of any suitable absolute dimensions D₁, D₂, L₁, L₂ depending on the corresponding dimensions of the particular door for which the reinforcement 10 is used.

The reinforcement 10 may be manufactured in any suitable manner and may be composed of any suitable material(s). For example, the reinforcement 10 may be composed of any wood, metal, or polymeric material. The phrase polymeric material generally includes relatively high-molecular-weight materials of either synthetic or natural origin and may include thermosets and/or thermoplastics. For example, the reinforcement 10 may be composed of a NYLON material. In any case, for use in reinforcing a door, the reinforcement is relatively rigid compared to the material of panels of the door. The reinforcement 10 may be machined, forged, molded, or the like.

FIG. 4 illustrates another presently preferred embodiment of a hollow door reinforcement 110. This embodiment is similar in many respects to the reinforcement 10 of FIGS. 1 through 3, and like numerals between the descriptions generally designate like or corresponding elements throughout the several views of the drawing figures. Additionally, the description of the reinforcement 10 is incorporated by reference into the following description and the common subject matter generally may not be repeated here.

The reinforcement 110 includes a body 112 and a flange 114 carried by the body 112. The body 112 is fluted for weight reduction and cost savings. Accordingly, the body 112 includes circumferentially spaced flutes 150 with spaces circumferentially interposed therebetween. The flutes 150 may be narrower at a front end 118 of the body 112 and wider at a rear end 122 of the body 112.

FIG. 5 illustrates a presently preferred embodiment of a door assembly 200. The assembly 200 may include a hollow door 260 carrying the door reinforcement 10 from FIGS. 1 through 3, a fastener 262, and hardware 264 attached to the fastener 262.

The door 260 may be any type of hollow door, for example, a bi-fold closet door. The door 260 may include a front panel 266 and a rear panel 268 spaced apart from the front panel 266 to define a space 270, which may be empty or may include one or more intermediate elements (not shown) for example, insulation, filler, ribbing, corrugated sheets, or the like. Accordingly, the door 260 may be substantially hollow except for such intermediate elements. The door 260 may be manufactured in any suitable manner and may be composed of any suitable materials, for example, wood, paperboard, metal, polymeric material, or the like. Moreover, the door 260 may be of any suitable thickness, for example, from 1″ to 2″ and, may be a 1⅜″ thick door. The front panel 266 may include a front surface 272, an oppositely disposed rear surface 274, and a fastener hole 276 therebetween. Similarly, the rear panel 268 may include a front surface 278, an oppositely disposed rear surface 280, and a reinforcement hole 282 therebetween.

The reinforcement 10 is adapted to be carried by the door 260 and may extend into and/or through the door 260. For example, the reinforcement 10 may be inserted into and through the reinforcement hole 282 and into abutment with the front panel 266. More specifically, the front surface 20 of the reinforcement body 12 may abut the rear surface 274 of the front panel 266 of the door 260. Similarly, the front surface 26 of the reinforcement flange 14 may abut the rear surface 280 of the rear panel 268 of the door 260. The body 12 may fit loosely to the rear panel 268 within the reinforcement hole 282, or may be fit to the rear panel 268 with an interference condition within the hole 282.

Once the reinforcement 10 is in place, the fastener 262 may be assembled to the reinforcement 10 and the door 260. For example, the fastener 262 may be inserted from the back of the door 260, through the fastener passage 16 of the reinforcement 10, through the fastener hole 276 of the front panel 266, and beyond the front surface 272 of the front panel 266. The fastener 262 may be any suitable article including a bolt, screw, or the like, and may include a head 284 and an elongated body 285 extending from the head to a hardware end 286, which may be threaded. As described previously, the flange 14 may be relatively thin or short compared to the body 12, so as to enable use of a fastener of standard or conventional length.

After the fastener 262 is in place, the hardware 264 may be attached to the fastener 262 in any suitable manner. The hardware 264 may be any suitable article or device including, for example, a decoration, handle, knob, or the like. For example, the hardware 264 may include a rear surface 288 disposed against the front surface 272 of the front panel 266 of the door 260, and a threaded hole 290 in the rear surface 288, which may be threaded to the threaded end 286 of the fastener 262.

The reinforcement 10 may help maintain an intended installation position of the hardware 264 for the hollow door 260 by reinforcing the hollow door 260 behind the hardware 264. More specifically, the reinforcement 10 may provide advantageous feature dimensions and ratios therebetween, as well as the opposed mounting surfaces 20, 28 of the flange 14 and body 12, which are configured to bear most, if not all, of the compressive fastening forces of the hardware fastening arrangement including the hardware 264 and the fastener 262. In other words, the reinforcement 10 provides rigid support for the door 260 directly behind the hardware 264 so that the hardware 264 can be tightened to the fastener 262 and, thus, to the door 260 without collapsing the door 260 and, therefore, without coming loose or wobbling.

The reinforcement 10 may be included as part of original equipment for a new door assembly, or may be a repair part for an existing door assembly. Also, because the reinforcement 10 may be inserted through the back of a door and may include advantageous feature dimensions and ratios therebetween, standard or conventional fasteners and hardware may be used for easy retrofit of an existing door assembly design.

An example method may include one or more of the following steps: 1) drilling a hole through a rear panel of a hollow door, coaxial with an axis of hardware to be carried at a front panel of the hollow door; 2) providing a reinforcement having a flange and a body extending from the flange; 3) inserting the reinforcement through the drilled hole so the flange abuts a rear surface of the rear panel and the body abuts a rear surface of a front panel of the hollow door; 4) inserting a fastener through a passage of the reinforcement from its rear; and 5) attaching the hardware to a hardware end of the fastener at a front surface of the front panel.

As used in the sections above and claims below, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components, elements, or items. Similarly, when introducing elements of the invention or the example embodiments thereof, the articles “a,” “an,” “the,” and “said” are intended to mean that there are one or more of the elements. Moreover, directional words such as front, rear, top, bottom, upper, lower, radial, circumferential, axial, lateral, longitudinal, vertical, horizontal, transverse, and the like are employed by way of description and not limitation. Other terms are to be construed using their broadest reasonable meaning unless they are used in a context that requires a different interpretation.

Finally, the foregoing description is not a definition of the invention, but is a description of one or more examples of presently preferred embodiments of the invention. The statements contained in the foregoing description relate to the particular examples and are not to be construed as limitations on the scope of the invention as claimed below or on the definition of terminology used in the claims, except where terminology is expressly defined above. And although the present invention has been disclosed using a limited number of examples, many other examples are possible and it is not intended herein to mention all of the possible manifestations of the invention. In fact, other modifications, variations, forms, ramifications, substitutions, and/or equivalents will become apparent to those skilled in the art in view of the foregoing description. The present invention is intended to embrace such forms, ramifications, modifications, variations, substitutions, and/or equivalents as fall within the spirit and broad scope of the following claims. In other words, the present invention encompasses many substitutions or equivalents of limitations recited in the following claims. For example, the materials, sizes, and shapes, described above could be readily modified or substituted with other similar materials, sizes, shapes, and the like. Therefore, the invention is not limited to the particular examples of presently preferred embodiments disclosed herein, but instead is defined solely by the claims below.

1. A door assembly comprising:
a door including:
a rear panel having a rear surface, a front surface, and a hole therebetween; and
a front panel spaced apart from the rear panel and having a rear surface and a front surface;
a reinforcement carried in the hole of the rear panel of the door and including:
an elongated body extending through the hole and having a front surface;
a flange larger than the hole, carried by the body, and having a rear surface and a front surface, which is disposed against the rear surface of the rear panel of the door; and
a fastener passage extending through the reinforcement between the rear surface of the flange and the front surface of the body;
a fastener including a head mounted against the rear surface of the flange of the reinforcement, and an elongated body extending from the head and through the fastener passage of the reinforcement to a hardware end; and
hardware attached to the hardware end of the fastener.

2. The door assembly of claim 1, wherein the front surface of the body is disposed against the rear surface of the front panel of the door.

3. The door assembly of claim 1, wherein the fastener is a screw and the hardware is a knob threaded to the hardware end of the fastener.

4. The door assembly of claim 1, wherein the body includes a radially outer dimension D₁ and the flange includes a radially outer dimension D₂, wherein a ratio of dimensions D₂ to D₁ ranges from about 1.4:1 to about 1.7:1, and wherein the body includes a longitudinal dimension L₁ and the flange includes a longitudinal dimension L₂, wherein a ratio of dimensions L₁ to L₂ range from about 25:1 to about 15:1.

5. The door assembly of claim 4, wherein the ratio of dimensions D₂ to D₁ is about 1.55:1, and wherein the ratio of dimensions L₁ to L₂ is about 20:1.

6. A reinforcement configured to be carried through a hole in a first of two spaced apart panels of a hollow door, comprising:
an elongated body configured to extend through the hole and to abut a second of the two spaced apart panels;
a flange larger than the hole, carried by the body, and configured to abut the first of the two spaced apart panels; and
a fastener passage extending through the flange and body.

7. The reinforcement of claim 6, wherein the body includes a radially outer dimension D₁ and the flange includes a radially outer dimension D₂, wherein a ratio of dimensions D₂ to D₁ ranges from about 1.1:1 to about 3.0:1, and wherein the body includes a longitudinal dimension L₁ and the flange includes a longitudinal dimension L₂, wherein a ratio of dimensions L₁ to L₂ range from about 30:1 to about 10:1.

8. The reinforcement of claim 7, wherein the ratio of dimensions D₂ to D₁ ranges from about 1.4:1 to about 1.7:1, and wherein the ratio of dimensions L₁ to L₂ ranges from about 25:1 to about 15:1.

9. The reinforcement of claim 8, wherein the ratio of dimensions D₂ to D₁ is about 1.55:1, and wherein the ratio of dimensions L₁ to L₂ is about 20:1.

10. The reinforcement of claim 9, wherein the dimension D₂ is about ¾″ and the dimension D₁ is about 31/64″, and wherein the dimension L₁ is about 1¼″ and the dimension L₂ is about 1/16″.

11. A door assembly comprising the reinforcement of any of claims 6 through 10.

12. A reinforcement configured to be disposed between spaced apart panels of a hollow door, comprising:
an elongated body;
a flange carried by the body; and
a fastener passage extending through the elongated body and the flange.

13. The reinforcement of claim 12, wherein the body includes a radially outer dimension D₁ and the flange includes a radially outer dimension D₂, wherein a ratio of dimensions D₂ to D₁ ranges from about 1.1:1 to about 3.0:1.

14. The reinforcement of claim 13, wherein the ratio ranges from about 1.4:1 to about 1.7:1.

15. The reinforcement of claim 14, wherein the ratio is about 1.55:1.

16. The reinforcement of claim 15, wherein the dimension D₂ is about ¾″ and the dimension D₁ is about 31/64″.

17. The reinforcement of claim 12, wherein the body includes a longitudinal dimension L₁ and the flange includes a longitudinal dimension L₂, wherein a ratio of dimensions L₁ to L₂ range from about 30:1 to about 10:1.

18. The reinforcement of claim 17, wherein the ratio ranges from about 25:1 to about 15:1.

19. The reinforcement of claim 18, wherein the ratio is about 20:1.

20. The reinforcement of claim 19, wherein the dimension L₁ is about 1¼″ and the dimension L₂ is about 1/16″.

21. A door assembly comprising the reinforcement of any of claims 12 through 20.
